(19) United States
(12) Patent Application Publication
(10) Pub. No.: US 2006/0056508 A1
(43) Pub. Date: Mar. 16, 2006

(54) Video coding rate control

(76) Inventors: Phillippe Lafon, Cagnes sur Mer (FR); Jennifer L. Webb, Dallas, TX (US)

Correspondence Address: TEXAS INSTRUMENTS INCORPORATED, P O BOX 655474, M/S 3999, DALLAS, TX, 75265, US

(21) Appl. No.: 11/218,407

(22) Filed: Sep. 1, 2005

Related U.S. Application Data
(60) Provisional application No. 60/606,968, filed on Sep. 3, 2004.

(51) Int. Cl. H04N 11/04; H04N 7/12; H04B 1/66; H04N 11/02

(52) U.S. Cl. 375/240.03; 375/240.12; 375/240.18; 375/240.24; 375/240.23

(57) ABSTRACT

Video encoding (such as H.263, MPEG4, H.264) modifies TMN5-type frame skipping and quantization parameter updates according to buffer fullness levels and makes I-frame initial quantization parameters depend upon prior P-frame quantization parameters.

### CROSS-REFERENCE TO RELATED APPLICATIONS

The present application claims priority from provisional patent application No. 60/606,968, filed Sep. 3, 2004. Co-assigned patent application No. 10/917,980, filed Aug. 13, 2004 (Webb and Magee), discloses related subject matter.

### BACKGROUND

The present invention relates to digital video signal processing, and more particularly to devices and methods for video coding.

There are multiple applications for digital video communication and storage, and multiple international standards have been and are continuing to be developed. Low bit rate communications, such as, video telephony and conferencing, led to the H.261 standard with bit rates as multiples of 64 kbps, and the MPEG-1 standard provides picture quality comparable to that of VHS videotape.

H.264/AVC is a recent video coding standard that makes use of several advanced video coding tools to provide better compression performance than existing video coding standards such as MPEG-2, MPEG-4, and H.263. At the core of all of these standards is the hybrid video coding technique of block motion compensation plus transform coding. Block motion compensation is used to remove temporal redundancy between successive images (frames), whereas transform coding is used to remove spatial redundancy within each frame. FIGS. 2a-2b illustrate H.264/AVC functions which include a deblocking filter within the motion compensation loop to limit artifacts created at block edges.

Traditional block motion compensation schemes basically assume that between successive frames an object in a scene undergoes a displacement in the x- and y-directions and these displacements define the components of a motion vector. Thus an object in one frame can be predicted from the object in a prior frame by using the object's motion vector. Block motion compensation simply partitions a picture (frame or interlace field) into blocks and treats each block as an object and then finds (motion estimation) a motion vector which locates the most-similar block in the prior frame. The most-similar block is a prediction of the current block and this prediction block can be encoded simply by the motion vector. This simple block motion assumption works out in a satisfactory fashion in most cases in practice, and thus block motion compensation has become the most widely used technique for temporal redundancy removal in video coding standards.

Typically, a frame is partitioned into macroblocks where each macroblock contains four 8×8 luminance (Y) blocks plus two 8×8 chrominance (Cb and Cr or U and V) blocks, although other block sizes, such as 4×4, are also used in H.264. The picture can be encoded either with motion compensation or without motion compensation. An I-frame is encoded without motion compensation (“intra-coded”) by simply applying the transform, quantization, and variable-length coding to each macroblock (or prediction error block using adjacent-pixel prediction). A P-frame is encoded (“inter-coded”) with motion compensation and a macroblock is encoded by its motion vector plus the transform, quantization, and variable-length coding of its residual block (prediction error block from the motion vector located block). The transform of a block converts the pixel values of a block from the spatial domain into a frequency domain; this takes advantage of decorrelation and energy compaction of transforms such as the two-dimensional discrete cosine transform (DCT) to make the quantization more effective. For example, in MPEG-2 and H.263, 8×8 blocks of DCT-coefficients are quantized, scanned into a one-dimensional sequence, and the sequence coded by using variable length coding. H.264 uses an integer approximation to a 4×4 DCT.

The rate-control unit in FIG. 2a is responsible for generating the quantization parameter (step size) by adapting to a target transmission bit-rate in view of the current fullness of the output buffer; a larger quantization parameter implies more vanishing and/or smaller quantized transform coefficients which means fewer and/or shorter variable-length codewords and consequent lower bit rates and smaller files. Of course, a larger quantization parameter also means more distortion in the frame decoded after transmission. Also, the predictive power of motion compensation generally leads to many more bits used encoding an I-frame than encoding a P-frame with comparable distortion.

Further, some low-rate applications may have an input at the typical 30 frames per second but only output 10 or 15 encoded frames per second. Thus input frames are skipped to adapt to the output encoded frame rate.

Telenor (Norwegian telecom) made an encoding implementation for H.263, denoted Test Model Near-term 5 or TMN5, publicly available; and this implementation has been widely adopted including use for MPEG4. The TMN5 rate control includes the function UpdateQuantizer( ) which generates a new quantization parameter (qp) based on the bits used up to the current macroblock in a frame and the bits used for encoding the prior frame. The function should be called at the beginning of each row of macroblocks (i.e., each slice), but it can be called for any macroblock.

However, the TMN5 encoder has problems including skipping input frames after outputting an I-frame, being designed for low-delay, low-bit-rate applications, and using a fixed quantization parameter for I-frames and only varying the quantization parameter for P-frames.

### SUMMARY OF THE INVENTION

The present invention provides H.263-type video encoding rate control with a nominal output buffer level together with a convergence factor for quantization parameter adaptation. Further preferred embodiment methods harmonize I-frame quantization parameters with P-frame quantization parameters.

### BRIEF DESCRIPTION OF THE DRAWINGS

FIG. 1 is a flowchart.

FIGS. 2a-2b are functional block diagrams of block-based motion compensation coding.

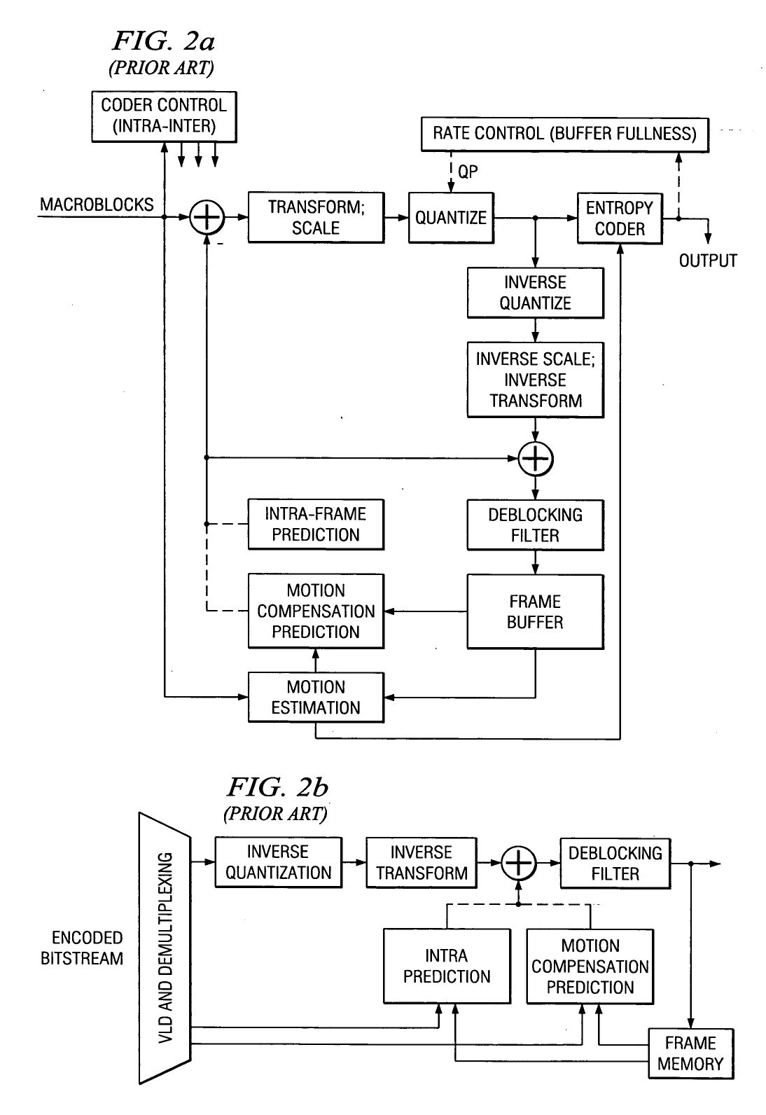

FIGS. 3a-3b show a processor and network connections.

### DESCRIPTION OF THE PREFERRED EMBODIMENTS

1. Overview

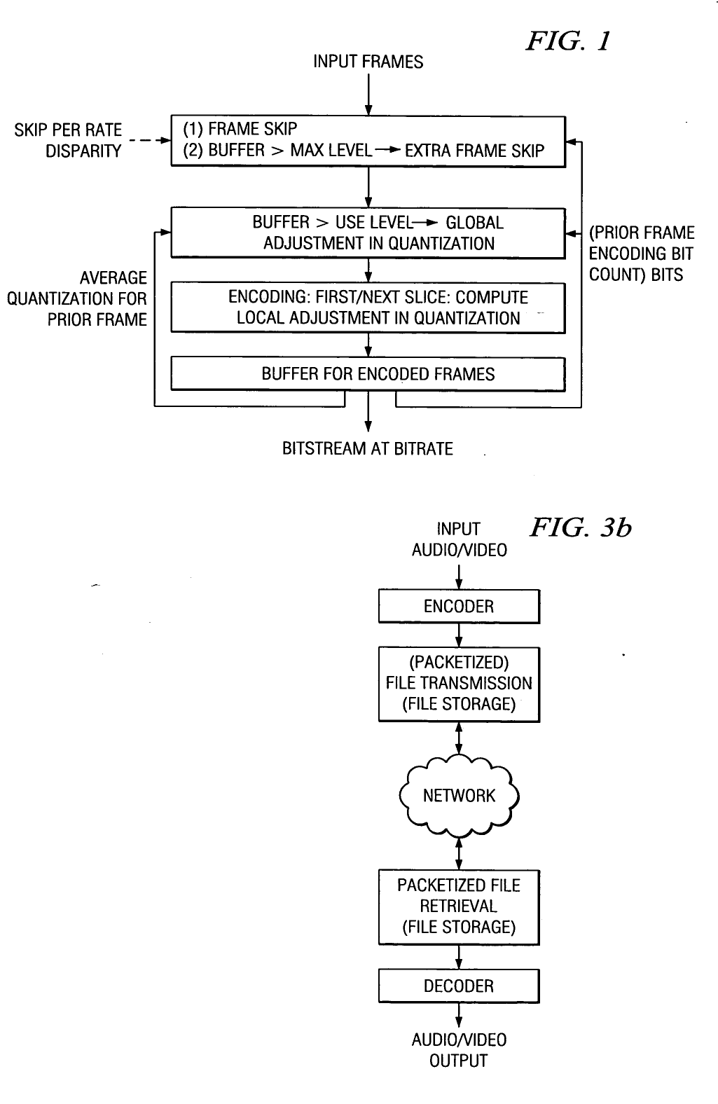

Preferred embodiment rate control methods extend the Telenor TMN5 type rate control for video encoding with more accurate adjustments adapting to buffer fullness. In particular, the methods set a nominal buffer level, denoted vbv_uselevel, that is equivalent to twice the number of bits allocated for an input frame (BitsPerFrame). Input frames are typically available at 30 frames per second, whereas a typical output encoded frame rate is 10 or 15 fps for low delay scenarios. In this case, vbv_uselevel corresponds to a delay of 1 output frame or less. The methods vary the quantization parameter QP for P-frames at the start of each row of macroblocks, using a variant of the TMN5 routines. TMN5 makes an adjustment based on the difference between the bit target for the output frame (B_target), and the actual number of bits used for encoding the previous output frame (B_prev). The preferred embodiment methods adjust QP not only to achieve B_target, but also to achieve vbv_uselevel. To do this, the methods increase or decrease B_prev with vbv_converge (and then call the TMN5 function UpdateRateControl). If the buffer fullness (CommBacklog) is getting high (above vbv_uselevel), then add CommBacklog/8 to B_prev, which will cause UpdateRateControl to raise QP more than it would otherwise. Conversely, if CommBacklog is getting low (below BitsPerFrame), reduce B_prev, which will cause UpdateRateControl to allow a lower QP than it would otherwise. By keeping the CommBacklog near vbv_uselevel, the preferred embodiment methods reduce frame skipping. FIG. 1 is a flowchart.

Note that vbv_converge only causes direct changes to QP for P-frames through UpdateRateControl.

For all preferred embodiment methods, the threshold for input frame skipping is vbv_maxlevel. A higher threshold allows more variability in bit rate, and corresponds to more delay. The first preferred embodiment methods take vbv_maxlevel equivalent of 3 times the bits allocated for an input frame. Anytime CommBacklog is greater than vbv_maxlevel, input frames will be skipped to let the buffer go down and reduce the delay. However, second and third preferred embodiment methods allow 1 second of delay by setting vbv_maxlevel to the bit rate (generally, 30 input fps). The larger vbv_maxlevel will accommodate periodic I-frames, instead of automatically skipping frames after an I-frame.

The preferred embodiment methods also have special checking for vbv_maxlimit, which represents the limit on bits per frame that is required by Annex D in MPEG-4 (VBV) and Annex B in H.263 (HRD). If a frame takes too many bits to code, the encoder will abort the frame, leaving the macroblocks at the bottom of the frame unchanged from the previous frame (or blank). Because aborting frames is undesirable, the preferred embodiment methods also limit vbv_maxlevel and vbv_uselevel relative to vbv_maxlimit.

The third preferred embodiment methods also adjust the I-frame quantization parameter QPI for the case of periodic I-frames or random insertion of I-frames. QPI is set (using API_changeQPI) to a weighted average of the previous QPI and a local QP factor that is adjusted based upon the number of bits used for the last frame coded. After encoding an I-frame, it is expected that the number of bits used will exceed B_target, (unless no P-frames are coded), because B_target represents an average over I- and P-frames. If the number of bits is too high or too low, the local QP factor is adjusted accordingly. Another goal is to keep QPI similar to the quantization parameter QP for the P-frames in order to maintain consistent quality. This avoids sudden changes in QPI, and also avoids large distortion differences between I-frames and P-frames.

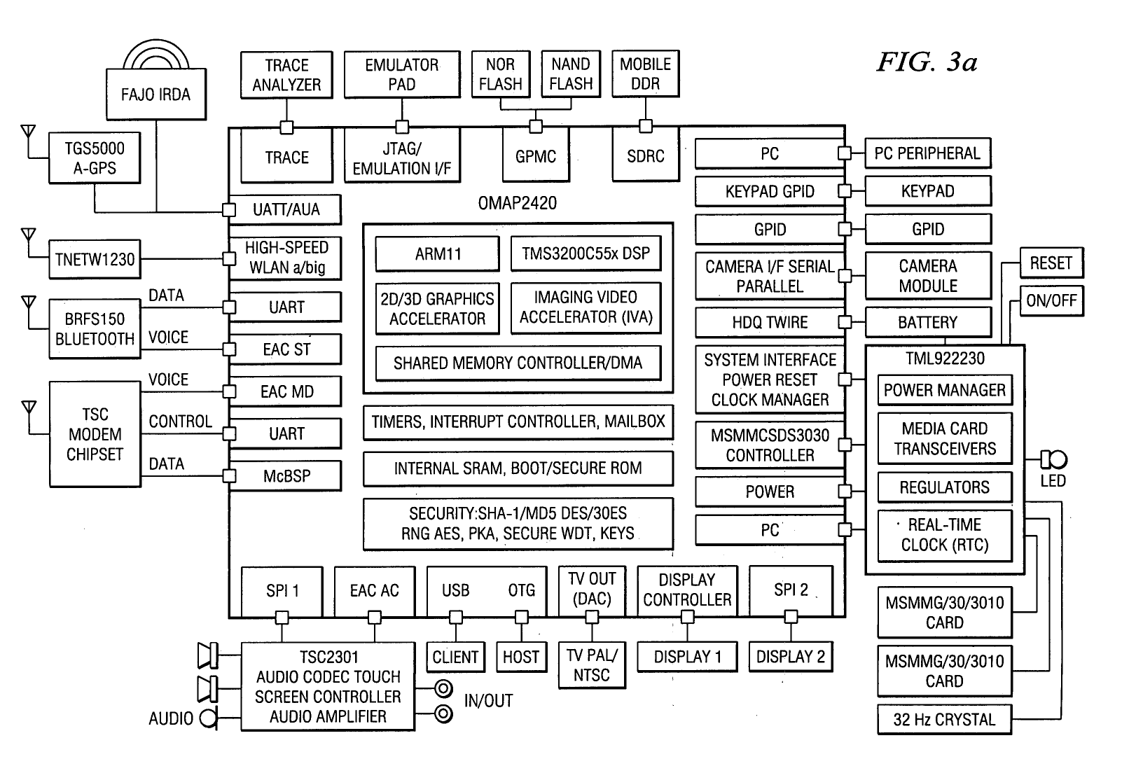

Preferred embodiment systems (e.g., video cellphones, PDAs, digital cameras, wireless notebook computers, etc.) perform preferred embodiment methods with any of several types of hardware, such as digital signal processors (DSPs), general purpose programmable processors, application specific circuits, or systems on a chip (SoC) such as multicore processor arrays or combinations such as a DSP and a RISC processor together with various specialized programmable accelerators (e.g., FIG. 3a). A stored program in an onboard or external (flash EEP)ROM or FRAM could implement the signal processing methods. Analog-to-digital and digital-to-analog converters can provide coupling to the analog world; modulators and demodulators (plus antennas for air interfaces such as for video on cellphones) can provide coupling for transmission waveforms; and packetizers can provide formats for transmission over networks such as the Internet as illustrated in FIG. 3b.

2. TMN5 Rate Control

First consider the operation of the TMN5 rate control with frames input at a rate of refframerate frames per second (fps), typically equal to 30, and encoded frames output at a frame rate of framerate fps and a bit rate of bitrate bits per second. If refframerate is greater than framerate, then input frames are periodically skipped to achieve the correct output frame rate. For example, input at 30 fps and output at 10 fps would imply skipping on the average two frames after each frame encoding. The output target is B_target bits per encoded output frame where B_target=bitrate/framerate. Analogously, the quantity BitsPerFrame=bitrate/refframerate is the number of output bits allocated per input frame; this would be an average taking into account the input frame skips due to differing input and output frame rates. After encoding a frame, the actual number of bits used, bits, is added to the buffer total, CommBacklog, and the number of bits allocated to be sent out of the buffer, BitsPerFrame, is subtracted from the buffer total:

CommBacklog = CommBacklog + bits; //add this picture bits
CommBacklog = CommBacklog − BitsPerFrame; //minus sent bits

Then the encoder moves to the next frame to be encoded by incrementing frameskip input frames;

```
frameskip = 1;
while (CommBacklog >= BitsPerFrame){
    CommBacklog −= BitsPerFrame;
    frameskip += 1;
}
```

so the actual frame rate depends on how closely the encoded output matches B_target.

During encoding a frame, the function UpdateQuantizer adjusts the quantization parameter (e.g., for transform coefficients) of a macroblock in order to make the number of bits being used for encoding the frame approximately B_target bits. Typically, the quantization parameter is adjusted at the beginning of each row of macroblocks.

In more detail, UpdateQuantizer applies the following four main steps to update of the quantizer parameter, QP:
projection=mb* (B_target/(mb_width*mb_height)); (1)
where mb is the number of the current macroblock, mb_height and mb_width are the number of rows and columns of macroblocks in the frame. Thus projection is simply B_target multiplied by the fraction of macroblocks already encoded, and consequently, it is just the targeted number of bits to have already been added to the output buffer due to the already-encoded macroblocks.
discrepancy=(bitcount−projection); (2)
where bitcount is the actual number of bits used encoding the already-encoded macroblocks; thus discrepancy may be either positive or negative and measures discrepancy between the actual and projected number of bits used for the already-encoded macroblocks.
local_{—}adj=12*discrepancy/bit_rate; (3)
The quantity local_adj will be part of a scale factor in the next step for adapting the quantization parameter, QP, to the number of bits being used.
newQP=(int)(QP_mean*(1+global_{—}adj+local_{—}adj)+0.5); (4)

and newQP updates QP during P-frame encoding. QP_mean is the average QP for the prior encoded frame and global_adj is an adjustment due to the final bit discrepancy of the prior encoded frame: global_adj=(B_prev−B_target)/(2*B_target) where B_prev is the number of bits used for the prior encoded frame and is updated prior to encoding the current frame by:

void UpdateRateControl(int bits)
{
B_prev = (float)bits;
}

Note that TMN5 only adjusts the quantization parameter during P-frame encoding, I-frame encoding uses a fixed quantization parameter, such as QPI=16.

3. First Preferred Embodiments

The first preferred embodiment methods are analogous to the TMN5 methods in that after encoding a frame, first the actual number of bits used, bits, increments the buffer content, CommBacklog, and the number of output bits allocated for an input frame, BitsPerFrame, decrements CommBacklog. Next, the number of input frames to skip is computed. Then the next frame to be encoded is processed with the quantization parameter adapting with both global_adj and local_adj. But the first preferred embodiment methods include target levels of output buffer fullness in order to (i) modify the input frame skipping and (ii) modify the global_adj part of the quantization parameter updating.

In particular, define two buffer fullness levels:

vbv_maxlevel = BitsPerFrame * 3; // 3 pics MAX
vbv_uselevel = BitsPerFrame * 2; // 2 pic typical

Since the bitrate may be very high it also includes limiters: limit vbv_maxlevel to one half of the buffer size and limit vbv_uselevel to one quarter of the buffer size.

First, when the buffer fullness exceeds vbv_maxlevel, skip extra input frame(s) by adjusting frameskip (the frame number increment to the next input frame to be encoded). Indeed, let Arg_chosen_frameskip control parameter denote the ratio between the reference frame rate and the target coded frame rate: coded frame rate=input frame rate/Arg_chosen_frameskip Then evaluate total frameskip by

```
frameskip = 1;
i = Arg_chosen_frameskip; //user required skip (target)
while( i−− > 1 ) {
    CommBacklog = CommBacklog − BitsPerFrame;
            //count skipped picture budget
    frameskip = frameskip + 1; //skip next
}
//skip extra picture if high level fullness occurs.
while( CommBacklog > vbv_maxlevel ) {
    CommBacklog = CommBacklog − BitsPerFrame;
    frameskip = frameskip + 1;
}
```

Also adjust CommBacklog in case of underflow (i.e., don't count non-existent data):

```
if( CommBacklog < Arg_buffer_backlog_limit ){
                //underflowed don't count
    CommBacklog = Arg_buffer_backlog_limit; // missing data
}
```

Typically, Arg_buffer_backlog_limit=0, and this indicates that the buffer count cannot have a negative number of bits when the number of actual bits, so far, is below the channel bit rate. However, in some file-based or streaming systems with added buffering, a negative value for CommBacklog buffer level is allowed. Negative Arg_buffer_backlog_limit indicates that if the actual bit rate is below the channel rate, then a limited number of unused bits can be allocated to future frames.

Second, for the quantization parameter update, include a convergence to the buffer fullness level vbv_uselevel using the variable vbv_converge to help adjust the quantization parameter. Compensation for the discrepancy between the current buffer level and the target vbv_uselevel is spread over time (a one second window, for example) and therefore vbv_converge actually is a convergence factor:

| vbv_converge = 0; | |
|---|---|
| if( CommBacklog > vbv_uselevel ) { | //getting high |
| vbv_converge = CommBacklog>>3; | //convergency factor |
| vbv_converge = mmin( vbv_converge, B_target ); //stability | |
| } | |
| if(CommBacklog < BitsPerFrame) { | //getting low |
| vbv_converge = − bits/2; | //convergency factor |

```
    EncState_QUANT −= (bits < B_target);
}
if( (CommBacklog + bits) > vbv_maxlevel ) {
    EncState_QUANT++;
}
//leave latest B_prev value from latest P picture
if (EncState_picture_coding_type != PCT_INTRA)
        UpdateRateControl(bits + vbv_converge);
```

Thus before encoding the current frame, if (CommBacklog+bits)>vbv_uselevel, increment the variable EncState_QUANT; if CommBacklog<BitsPerFrame, decrement EncState_QUANT; and when the current frame is to be a P-frame, update B_prev to bits+vbv_converge rather than just to bits (the number of bits used to encode the prior frame). Consequently, global_adj=(B_prev−B_target)/(2*B_target) will be larger when CommBacklog>vbv_uselevel and smaller when CommBacklog<BitperFrame. Thus the quantization parameter updating:
newQP=(int)(QP_mean*(1+global_{—}adj+local_{—}adj)+0.5);
will give correspondingly larger or smaller updates than without the preferred embodiment vbv_converge term.

The EncState_QUANT variable is the value of the quantization parameter at the end of encoding the prior frame, and it is used for initialization. Further, EncState_QUANT is constrained to a user-defined quantization parameter range:

EncState_QUANT = mmin(Arg_QP_max, EncState_QUANT);
EncState_QUANT = mmax(Arg_QP_min, EncState_QUANT);

In summary, the first preferred embodiment methods modify adjustments for the quantization parameter updates through the global_adj and EncState_QUANT variables.
4. Second Preferred Embodiments

Second preferred embodiment video coding rate control methods are like the first preferred embodiment methods but with a change to the buffer fullness measure vbv_maxlevel in order to limiting skipping of extra input frames.

In particular, the two buffer levels are redefined as:

vbv_maxlevel = BitsPerFrame * (Arg_ref_frame_rate>>10);
// approximately 1 second of video
vbv_uselevel = BitsPerFrame * 2; // 2 pic typ

where Arg_ref_frame_rate is the input frame rate (in Q10 format, so the >>10 gets the integer part), typically about 30. Thus the second preferred embodiments would have a much larger vbv_maxlevel and this accommodates periodic I-frames, in that compensation for a large excess of coded bits used during I picture coding will be spread over time (thanks to vbv_converge); the goal being to avoid skipping frames to compensate from this I-frame bit excess. It is assumed here that I-frames may occur in a random manner, under the condition that a certain amount of time exists between two I-frames (order of magnitude of one second, at least).
5. Third Preferred Embodiment

Third preferred embodiment video coding rate control methods are like the second preferred embodiment methods plus a change to the quantization parameter at the start of an I-frame. These changes allow full adaptation to random Inra picture insertions at any period of occurrence, and maintain a homogenous visual quality. The model harmonizes the quantization for I-frames to the value during the P-frames. In addition specific controls take care, when quantization is low to avoid risk of overflow.

```
/*** adapt Quant For next Intra
/*** try to be consistent with last P coding quality */
    QP = EncState_QUANT;
    /*** Adjust QPI depending on this I picture event */
    if (EncState_picture_coding_type == PCT_INTRA) { //I pic
        if( bits > (2*B_target) )
            QP += (EncState_QUANT+3)>>2;
        if( bits > (4*B_target) )
            QP += (EncState_QUANT+3)>>2;
        if( bits > B_target+(B_target>>3) )
            QP += (EncState_QUANT > 6);
        if( bits < B_target−(B_target>>3) )
            QP −= (EncState_QUANT > 6);
        if( bits < B_target−(B_target>>2) )
            QP −= (EncState_QUANT+7)>>3;
        if( bits < B_target>>1 )
            QP −= (EncState_QUANT+4)>>3;
    }
    /*** To limit frame limits if next pic is I */
    if (EncState_picture_coding_type != PCT_INTRA) {
        if( QP < 4 ) QP++;
        /*** To avoid approaching vbv_maxlevel */
        if( ((bits * 8) + CommBacklog) > vbv_maxlevel )
            QP += (EncState_QUANT+7)>>3;
        /*** To avoid frame too big to occur */
        else if( (bits * 8) > frame_too_big )
            QP += (EncState_QUANT+7)>>3;
        if( (bits * 4) > frame_too_big )
            QP += (EncState_QUANT+7)>>3;
    }
    QP = (3 * QP + (Arg_QPI) + 2) / 4; // weighted average
    // Next I pic Quant
    API_ChangeQPI( QP );
```

Thus a QPI value is calculated after each coded picture; and the calculation uses the currently coded picture type. The result is then used to re-initialize the Intra quantization Arg_QPI (using API_changeQPI) in the case the next incoming picture would be an Intra picture.

After coding an I-frame, it is expected that the number of bits used, bits, will exceed B_target, because B_target represents an average over I- and P-frames. If the number of bits is too high or too low, the local QP factor adjusts accordingly. Another goal is to keep QPI similar to the QP used for the P-frames in order to maintain consistent quality; consequently, the local QP factor is initialized with EncState_QUANT. This avoids sudden changes in QPI, and also avoids large distortion differences between I-frames and P-frames.

The third preferred embodiments adjustment of initial I-frame quantization parameter especially helps avoid frame skips for encoding all I-frames or alternating I- and P-frames with any type of periodicity. Note that large size frames (e.g., VGA) and high frame rates require more cycles to encode due to the high-quality motion estimation needed; but with high bit rates coding all I frames or alternating I- and P-frames lessens the computational complexity.

6. Examples

Some numerical examples will help explain the foregoing descriptions of the preferred embodiments.

(1) As an example using the first preferred embodiment methods, presume a 30 fps input frame rate (refframe rate=30) but a lower output frame rate of 15 fps (framerate=15) with a low bit rate (for video) of 30 kbps (bit_rate=30000); this implies a target of 2000 bits per output frame (B_target=2000) and a bit allocation of 1000 bits per input frame (BitsPerFrame=1000). Then for the first preferred embodiments vbv_maxlevel=BitsPerFrame*3=3000, vbv_uselevel=BitsPerFrame*2=2000, Arg_chosen_frameskip=refframerate/framerate=2.

After an initial I-frame, encode as P-frames. Presume after frame #0 is encoded (as an I-frame that used 11000 bits), the output buffer contains about 10000 bits (which will be transmitted in the next ⅓ second), and
CommBacklog=Commbacklog+bits;
CommBacklog=CommBacklog−BitsPerFrame;
has computed CommBacklog=10000. The next encoded frame will be a P-frame.

First, while (i - ->1) executes once and gives frameskip=2 and reduces CommBacklog to 10000−1000=9000.

Second, the while (CommBacklog>vbv_maxlevel) executes six times to update frameskip to 8 and reduce CommBacklog to 3000. Thus the next frame encoded is frame #8 and as a P-frame. Without this vbv_maxlevel-based adjustment, CommBacklog would be reduced to BitsPerFrame=1000 and the next encoded frame would be frame #10.

Third, if (CommBacklog>vbv_uselevel) is true, so compute vbv_converge=3000/8=375.

Fourth, if (EncState_picture_coding_type!=PCT_INTRA) UpdateRateControl (bits+vbv_converge);

Because frame #0 was an I-frame, this is not executed (note that EncState_ . . . variables relate the prior frame's encoding), so vbv_converge has no effect until after the first P-frame.

Presume 3100 bits are used to encode frame #8 as a P-frame.
CommBacklog=CommBacklog+bits;
CommBacklog=CommBacklog−BitsPerFrame;
then compute CommBacklog 3000+3100−1000=5100. The next encoding will be another P-frame.

First, while (i - ->1) executes once and gives frameskip=2 and reduces CommBacklog to 5100−1000=4100.

Second, the while (CommBacklog>vbv_maxlevel) executes two times to update frameskip to 4 and reduce CommBacklog to 2100. Thus the next frame encoded is frame #12 and as a P-frame.

Third, if (CommBacklog>vbv_uselevel) is true, so compute vbv_converge=2100/8=252. Thus compute B_prev=3100+262=3362 and hence global_adj=(B_prev−B_target)/(2*B_target)=(3362−2000)/4000=0.34 for encoding frame #12 as a P-frame. Without the vbv_uselevel-based adjustment, global_adj=(3100−2000)/4000=0.275; so the first preferred embodiment methods both skip fewer input frames, with smaller intervals, than TMN5 and compensate for buffer level by increasing the following P-frame quantization parameter more than TMN5.

(2) As an example using the second preferred embodiment buffer levels, consider the same setup as in the first example. For the second preferred embodiment methods, assume one I-frame per second. In particular, vbv_maxlevel=BitsPerFrame*30 30000 ((Arg_ref_frame_rate>>10)=30), vbv_uselevel=BitsPerFrame*2=2000.

In this case, while(i - ->1) again executes once to give frameskip=2 and CommBacklog=9000. But while(CommBacklog>vbv_maxlevel) does not execute, so frameskip and CommBacklog are unchanged and frame #2 is the next frame encoded.

Again, if (CommBacklog>vbv_uselevel) is true, so compute vbv_converge=9000/8=1125.

However, if (EncState_picture_coding_type!=PCT_INTRA) UpdateRateControl(bits+vbv_converge); is not executed, and vbv_converge has no effect until after the first P-frame.

Presume the first P-frame (frame #2 in this case) is encoded with 3100 bits, yielding CommBacklog=9000+3100−1000=11100.

Again, while(i - ->1) executes once and gives frameskip=2 and reduces CommBacklog to 11100−1000=10100.

As before, the while(CommBacklog>vbv_maxlevel) does not execute. Thus the next frame encoded is frame #4 and as a P-frame.

Again, if (CommBacklog>vbv_uselevel) is true, so compute vbv_converge=10100/8=1262. Thus compute B_prev=3100+1262=4362 and hence global_adj=(B_prev−B_target)/(2*B_target)=(4362−2000)/4000=0.59 for encoding frame #4 as a P-frame. Without the vbv_uselevel_based adjustment, global_adj=(3100−2000)/4000=0.275; so the second preferred embodiment methods significantly reduce frame skipping and regulate the buffer level by increasing (or decreasing) the quantization parameter, compared to TMN5.

(3) As a example of the third preferred embodiment methods, again consider the setup of the first and second examples. For the third preferred embodiment, presume the output encoded frame pattern is IPPIPP . . . where encoding an I-frame is expected to use about 5000 bits and encoding a P-frame is expected to use about 500 bits (so the average is 2000 bits=B_target); and continue to the next I-frame to see the effect. The buffer levels are the same as in the second example, and so frame #2 is encoded as a P-frame with the same quantization parameters. Presume 3100 bits were used to encode frame #2. Again, after frame skipping, CommBacklog=10100, and the next frame to be encoded is #4.

For the third preferred embodiment, an adjustment is made to Arg_QPI based on the prior frame. Because if ( ((bits*8)+CommBacklog)>vbv_maxlevel ) is true, Arg_QPI is set to a weighted average QP=(3*QP+(Arg_QPI)+2)/4; where QP+=(EncState_QUANT+7)>>3 is approximately 12.5% higher than the final QP for the P-frame. Even though the next frame is not an I-frame, this adjustment will affect future weighted average computations.

```
if (EncState_picture_coding_type != PCT_INTRA) {
    if( QP < 4 ) QP++;
    /*** To avoid approaching vbv_maxlevel */
    if( ((bits * 8) + CommBacklog) > vbv_maxlevel )
                    QP += (EncState_QUANT+7)>>3;
    /*** To avoid frame too big to occur */
    else if( (bits * 8) > frame_too_big )
                    QP += (EncState_QUANT+7)>>3;
    if( (bits * 4) > frame_too_big )
                    QP += (EncState_QUANT+7)>>3;
}
```

Again, if (CommBacklog>vbv_uselevel) is true, so compute vbv_converge=10100/8=1262. We compute B_prev=3100+1262=4362 and thus global_adj=(B_prev−B_target)/(2*B_target)=(4362−2000)/4000=0.59 for encoding frame #4 as a P-frame. Without the vbv_uselevel-based adjustment, global_adj=(3100−2000)/4000=0.275;
Presume frame #4 is encoded with 2100 bits. Then
CommBacklog=CommBacklog+bits;
CommBacklog=CommBacklog−BitsPerFrame;
gives CommBacklog=10100+2100−1000=11200.

Again, while(i - ->1) executes only once to give frameskip=2 and decrements CommBacklog=11200−1000=10200. But while(CommBacklog>vbv_maxlevel) does not execute, so frameskip and CommBacklog are unchanged and frame #6 is the next frame to be encoded and will be an I-frame.

Now, if (CommBacklog>vbv_uselevel) is again true, so compute vbv_converge=10200/8=1275; but frame #6 will be an I-frame, so vbv_converge will modify global_adj for the next P-frame #8. Also, if ((CommBacklog+bits)>vbv_maxlevel) is false, so EncStateQUANT is unchanged.

Again, for the third preferred embodiment, an adjustment is made to Arg_QPI after encoding each frame. Because if ( ((bits*8)+CommBacklog)>vbv_maxlevel ) is false, Arg_QPI is set to a weighted average QP=(3*QP+(Arg_QPI)+2)/4; where QP=EncState-QUANT is the final QP for frame #4. This maintains consistency between the QP for P-frames and I-frames, to avoid a sudden change in visual quality.

Presume 6000 bits were used to encode frame #6.

Next,
CommBacklog=CommBacklog+bits;
CommBacklog=CommBacklog−BitsPerFrame;
gives CommBacklog=10200+6000−1000=15200.

Again, while(i - ->1) executes only once to give frameskip=2 and decrements CommBacklog=15200−1000=14200. But while(CommBacklog>vbv_maxlevel) does not execute, so frameskip and CommBacklog are unchanged and frame #8 is the next frame to be encoded and will be another P-frame.

Before frame #8, if (CommBacklog>vbv_uselevel) is again true, so compute vbv_converge=14200/8=1775, but if ((CommBacklog+bits)>vbv_maxlevel) is false and so EncStateQUANT is unchanged.

And if
(EncState_picture_coding_type!=PCT_INTRA) UpdateRateControl (bits+vbv_converge);

does not execute, because the previous frame was INTRA coded, but the values from the last P-frame, frame #4, will apply to compute global_adj for frame #8. For the third preferred embodiment, an adjustment is made to Arg_QPI based on the prior frame.

```
    QP = EncState_QUANT;
    if (EncState_picture_coding_type == PCT_INTRA) {
          if( bits > (2*B_target) )
            QP += (EncState_QUANT+3)>>2;
        if( bits > (4*B_target) )
            QP += (EncState_QUANT+3)>>2;
        if( bits > B_target+(B_target>>3) )
            QP += (EncState_QUANT > 6);
        if( bits < B_target−(B_target>>3) )
            QP −= (EncState_QUANT > 6);
        if( bits < B_target−(B_target>>2) )
            QP −= (EncState_QUANT+7)>>3;
        if( bits < B_target>>1 )
            QP −= (EncState_QUANT+4)>>3;
}
```

There are two true if statements: if ( bits>(2*B_target) ) and if (bits>B_target+(B_target>>3) ), because bits=6000 and B-target =2000. Suppose EncState_QUANT=20. Consequently, QP=20+(20+3)>>2=25, then QP=25+1=26, because (EncState_QUANT>6) is true. Then average (with 3 to 1 weights) this local QP and the I-frame quantization parameter Arg_QPI. Lastly, take this average as the initial quantization parameter for encoding the next I-frame or for the next weighted average, whichever is first:
QP=(3*QP+(Arg_{—}QPI)+2)/4;
API_changeQPI(QP);
For example, if Arg_QPI=16, then the new QPI=24. That is, the initial quantization parameter for an I-frame is influenced by the quantization parameter for the preceding frame rather than some value independent of the preceding frame's quantization parameter.

Thus, for the third preferred embodiment methods, Arg_QPI adapts, and QP gradually rises to reduce the buffer level, while avoiding additional frame skips. TMN5 would generally skip frames after every I-frame, since the P-frame logic does not compensate for the buffer level.

7. Modifications

The preferred embodiments can be varied while retaining one or more of the features of quantization parameter adjustment with a convergence factor based on output buffer fullness level and I-frame quantization parameter adjustment according to prior frame quantization parameter.

For example, the values of vbv_uselevel and vbv_maxlevel could be other multiples of BitsPerFrame; vbv_converge could be a different fraction of CommBacklog; the thresholds for and sizes of the adjustments to the local QP could be varied; Arg_QPI, currently updated every frame after the second frame, could be updated after the first frame, or less often, if not encoding all I-frames; a vbv_converge factor from could be added to B_prev for I-frames, and . . .

What is claimed is:

1. A method of video encoding, comprising:
(a) providing a bit target for encoding an input frame of an input video sequence;
(b) providing an encoded frame output buffer fullness level;
(c) providing a content measure of said buffer;
(d) computing a convergence factor when said content measure exceeds said fullness level;
(e) computing a discrepancy between said bit target and the number of bits used to encode a frame prior to said input frame with adjustment by said convergence factor;
(f) from the results of step (d), computing an adjustment to a quantization parameter for said input frame.

2. The method of claim 1, wherein:
(a) said quantization parameter is adjusted prior to encoding each row of macroblocks of said input frame using both a local adjustment result and a global adjustment result, said local adjustment result depends upon a numbers of bits used encoding prior rows of macroblocks of said input frame and said global adjustment depends upon said results of step (d) of claim 1.

3. The method of claim 1, wherein:
(a) when said content measure exceeds said fullness level, said convergence factor is said content measure divided by 8.

4. The method of claim 1, further comprising:
(a) providing an encoded frame output buffer fullness second level; and
(b) when said content measure exceeds said fullness second level, skipping steps (d)-(f) of claim 1 for said input frame.

5. The method of claim 4, wherein:
(a) said fullness level equals twice said a number of encoding bits allocated per frame of said input video sequence; and
(b) said fullness second level equals thrice said number of encoding bits allocated.

6. The method of claim 5, wherein:
(a) when said content measure is less than said number of encoding bits, said convergence factor is one-half of a number of bits used encoding a frame prior to said input frame.

7. The method of claim 1, wherein:
(a) when said frame prior to said input frame was encoded as a predicted frame, said adjustment of said number of bits used to encode of step (e) of claim 1 is the addition of said convergence factor to said number of bits used to encode.

8. The method of claim 1, further comprising:
(a) when said frame prior to said input frame was encoded as a predicted frame, incrementing an initial quantization parameter for a non-predicted frame if said number of bits used to encode multiplied by 8 plus said content measure exceed said fullness second level.

9. An encoder for video, comprising:
(a) motion compensation circuitry including a block transformer, a quantizer, an inverse quantizer, an inverse block transformer, a block motion estimator, and a block motion compensation predictor;
(b) an entropy encoder coupled to output of said quantizer;
(c) a rate controller with input coupled to output of said entropy encoder and with output coupled to input for said quantizer, said rate controller operable to adjust a quantization parameter by (i) computing a bit target for encoding an input frame of an input video sequence, (ii) computing an encoded frame output buffer fullness level, (iii) computing a content measure of said buffer, (iv) computing a convergence factor when said content measure exceeds said fullness level, (v) computing a discrepancy between said bit target and the number of bits used to encode a frame prior to said input frame with adjustment by said convergence factor, and (vi) computing an adjustment to a quantization parameter for said input frame using said discrepancy.

10. The encoder of claim 9, wherein:
(a) said circuitry, said entropy encoder, and said rate controller are implemented as a program on a programmable processor.
